(19) United States
(12) Patent Application Publication
(10) Pub. No.: US 2002/0196331 A1
(43) Pub. Date: Dec. 26, 2002

(54) Method for reading out a detection chip of an electronic camera

(75) Inventor: Klaus Rinn, Heuchelheim (DE)

Correspondence Address: FOLEY AND LARDNER, SUITE 500, 3000 K STREET NW, WASHINGTON, DC, 20007, US

(73) Assignee: LEICA MICROSYSTEMS SEMICONDUCTOR GmbH

(21) Appl. No.: 10/170,623

(22) Filed: Jun. 14, 2002

(30) Foreign Application Priority Data
Jun. 15, 2001 (DE) 101 29 818.8

(51) Int. Cl. H04N 13/02

(52) U.S. Cl. 348/50

(57) ABSTRACT

The present invention concerns a method for reading out a detection chip of an electronic camera in a coordinate measuring instrument for determining the position of an edge of a feature on a substrate, having at least two digitization devices reading out the detection chip, with each of which individual pixels of the detection chip are associated, the digitized data read out by the digitization devices being subjected to a data reduction in order to extract characteristic measurement parameters. The method is intended to make it possible for the detected image data of a large-format camera to be equalized, and optionally for characteristic measurement parameters to be extracted, even at a high readout rate, with the computational capacity essentially of a fast personal computer. The method according to the present invention for reading out a detection chip of a camera is characterized in that an equalization of the reduced digitized data of the various digitization devices is accomplished with a correction function.

### CROSS REFERENCE TO RELATED APPLICATIONS

This application claims priority of the German patent application 101 29 818.8 which is incorporated by reference herein.

### FIELD OF THE INVENTION

The present invention concerns a method for reading out a detection chip of an electronic camera, having at least two digitization devices reading out the detection chip, with each of which individual pixels of the detection chip are associated, the digitized data read out by the digitization devices being subjected to a data reduction in order to extract characteristic measurement parameters.

### BACKGROUND OF THE INVENTION

Electronic cameras, for example CCD cameras or CMOS cameras, have been known from practical use for some time and are used in many applications. In microscopy in particular, CCD cameras serve as detectors with which the specimen imaged by the microscope optical system is detected. In particular in the metrology of line widths or positions on substrates of the semiconductor industry, CCD cameras that furnish images to television standards are used. As a result of increasingly stringent requirements in terms of image field size, CCD cameras with a larger detection chip image format—for example, 1000×1000 pixels—are now being used. Correspondingly, more than twice as many pixels need to be read out as in the case of CCD cameras that conform to the television standard. If the standard television frame rate is to be maintained (NTSC standard: 30 frames per second; PAL standard: 25 frames per second), then a larger image field size means that the rate at which the pixels are read out is more than doubled.

In industrial applications, for example in the metrology of line widths or positions on substrates of the semiconductor industry, coordinate measuring instruments such as those described in German patent application DE 198 19 492.7-52 are used. This measuring instrument is used for high-precision measurement of coordinates of features on substrates, e.g. masks, wafers, flat-panel screens, and vacuum-deposited features, but in particular for transparent substrates. The coordinates are determined relative to a reference point, to an accuracy of a few nanometers.

In the metrology of line widths or positions on substrates of the semiconductor industry, the detected images are digitally processed in order to extract characteristic measurement parameters. Analog-digital converters (ADCs) are used for this purpose as the digitization device for digitization of the analog data. If a CCD camera with a larger image format and a frame rate corresponding to the television standard is then used, a single ADC is overloaded. At present, therefore, large-format digital CCD cameras with frame rates exceeding 20 Hz are read out by two or four ADCs.

In measurement technology, the problem occurs that multiple ADCs can never operate exactly identically. This causes differences to occur in the digitized data read out by the individual ADCs, which differences on the one hand are not constant over the image field and on the other hand depend nonlinearly on the gray values or pixel values, i.e. on the detected intensities of the individual pixels. If the application demands high accuracy in the detected image data, these error contributions are not tolerable.

Provision could be made for pixel-by-pixel correction of these errors, in which context, for example, the differences in the read-out image data of the particular digitization device of a detected image are ascertained as a function of pixel intensity value and position in the image field. Each pixel in an image could then be corrected, with the difference thus ascertained or with a correction value, as a function of the image position and pixel intensity. These corrected images could then be conveyed to a downstream evaluation function in which characteristic measurement parameters are extracted, ultimately yielding information about the detected specimens.

A problem with these suggested solutions is that even with fast personal computers, the computational performance necessary for them at such a high data rate can be achieved in real time, if at all, only with very simple operations. For example, with a CCD camera having an image format of 1000×1000 pixels per image, 8-bit dynamics, and a readout rate of 30 Hz, the resulting data rate would be 30 MB/sec, so that the personal computer is at full capacity, if not overloaded, simply in order to correct the data read out by the ADCs. An additional processing step, for example in the form of digital image processing in order to extract characteristic measurement parameters, is then no longer possible with that personal computer.

### SUMMARY OF THE INVENTION

It is therefore the object of the present invention to describe and develop a method of the generic type for reading out a detection chip of an electronic camera with which the detected image data of a large-format camera can be equalized, and optionally characteristic measurement parameters can be extracted, even at a high readout rate, with the computational capacity essentially of a fast personal computer.

The method according to the present invention of the generic type achieves the aforesaid object by way of the features of claim 1. According to the latter, a method of this kind is characterized in that an equalization of the reduced digitized data of the various digitization devices is accomplished with a correction function.

What has been recognized according to the present invention is firstly that for almost all applications in which characteristic measurement parameters are extracted, the correction step or the equalization of the digitized data of the various digitization devices can be displaced further back in the sequence of processing steps to be performed without substantially reducing detection quality. The earlier processing steps can consequently be performed on the non-equalized digitized data of the various digitization devices, even though in the context of the earlier processing steps a data reduction, for example by averaging, has been accomplished. Equalization of the digitized data of the various digitization devices is thus applied only to a reduced data volume, so that in particularly advantageous fashion, even computing operations of greater calculation complexity would be possible in the context of equalization without thereby overloading a personal computer used for the purpose.

The data reduction of the digitized data of the various digitization devices could encompass a projection onto a line in an image detected by the camera. Preferably the projection is an orthogonal projection. For example an orthogonal projection (constituting the data reduction) onto the bottom row of the detection chip of the CCD camera could correspond to a reduction by a factor of 1000, if the detection chip of the CCD camera has 1000×1000 pixels. Such a projection would be advisable, however, only if the detected image does not change along the projection direction, for example if the detected image comprises multiple conductor paths extending parallel to the projection direction, said image having been generated by means of a microscope of a coordinate measuring instrument. A data reduction could also encompass a summation and, in particular, an averaging. In the context of such a reduction, a summation or an averaging of individual rows or columns of the detection chip of the camera could be provided, in particular if the pixels of the detection chip that are associated with the digitization devices are combined into rows or columns.

Usually the same number of pixels will be associated with each digitization device. This is the case, for example, if all the even-numbered lines are digitized by a first digitization device, and all the odd-numbered lines of the detection chip are digitized by a second digitization device.

An ADC (analog-digital converter) could serve as the digitization device. An ADC preferred for use here has a dynamic range of 8 bits, i.e. it converts the analog voltages into digital values between 0 and 255. ADCs with a greater dynamic range could also be used.

In very particularly preferred fashion, the correction function has a position-dependent part and an intensity-dependent part. In general, the correction function will be representable by an analytic function that can be represented, for example, as the product, sum, or some other mathematical combination of an exclusively position-dependent part and an exclusively intensity-dependent part. In a concrete case, the correction function comprises the product of an exclusively position-dependent part and an exclusively intensity-dependent part.

The intensity-dependent portion of the correction function depends on the detected intensity of the individual pixels, so that this part of the correction function is to be applied to the data presently being digitized. The location-dependent part of the correction function refers to the position of the pixels of the detection chip. This part of the correction function is, in particular, not dependent on the detected intensity of the individual pixels.

In very particularly preferred fashion, the detection chip is used as the position detector of a coordinate measuring instrument such as the one described, for example, in German patent application DE 198 19 492.7-52.

The separability of the correction function into a position-dependent part and an intensity-dependent part proves to be very particularly advantageous for the case in which only one measurement window or only one region of interest (ROI) of the detection chip of the camera is taken into consideration or measured for extraction of the characteristic measurement parameters. In that context, this could be a portion of the image detected with the camera that contains a specimen area of interest or a specimen of interest. Equalization of the reduced digitized data of the various digitization devices with the correction function could accordingly refer only to one ROI, so that as a result, in further advantageous fashion, the computational performance required for correction is reduced even further.

For many applications, it may be necessary for a rectangular ROI oriented arbitrarily in the image to be transformed, by means of a computationally performed rotation and optionally an interpolation associated therewith, in such a way that after the rotation the ROI is oriented parallel to the outer edges of the detection chip of the camera.

One example of an embodiment for a specific evaluation method could be a conductor path, extending diagonally with respect to the detection chip of the CCD camera, that was imaged with a microscope of a coordinate measuring instrument onto the detection chip of the CCD camera. For further analysis or for the extraction of characteristic measurement parameters of the conductor path, a rectangular ROI is defined in such a way that it extends with its edges parallel to the conductor path, and contains the conductor path at least over a longer region. For further processing of the image data of the ROI, as is known for example from DE 198 25 829 A1, an artificial pixel grid is generated by interpolation from the brightnesses of the physically existing pixels, and further calculation can be performed on this as on the real pixel grid of an unrotated ROI.

A mathematical function having free parameters can be selected as the correction function. A fit function which is linear or nonlinear in position or in intensity, which either results from a knowledge of the characteristic properties of the camera being used or optionally is ascertained empirically, can be used as the correction function. For the free parameters, concrete values for an optimum correction are ascertained in the context of a calibration as follows:

Firstly, a series of images of a uniform specimen with homogeneous illumination is detected, using different illumination intensities and/or different exposure times. With a perfect detection system, all the intensities within all the images should be identical, i.e. the correction function to be determined must suppress the intensity differences in the image.

In other words, the corrected brightnesses of the pixels are considered. The differences in the corrected brightnesses with respect to adjacent pixels of the respective other digitization device are then determined. Thus, for example, if a first digitization device has all even-numbered rows of the detection chip associated with it, and a second digitization device has all odd-numbered rows of the detection chip associated with it, a difference would need to be determined in the resulting averages of the adjacent rows. If several digitization devices are associated with one detection chip, for example if each digitization device has four directly adjacent columns associated with it, then the average of four columns at a time is ascertained, and the difference with respect to the average of the group (adjacent to the four columns) of the next four columns of the other digitization device is determined. From all the differences, a number is calculated which characterizes the total error, e.g. as the sum of the magnitudes of the differences, as the sum of the squares of the differences, or as the quantitatively largest difference. The free parameters of the correction function are then determined in such a way that this total error is minimal. In mathematical terms, what is desired is the minimum of the total error as a function of the free parameters of the correction function. The mathematical literature offers a wealth of suitable methods for this purpose. One such method, for example in the context of a correction function which interpolates linearly into the free parameters, is the Gaussian method of least error squares.

In the interest of simple and rapid execution of the correction of the data to be detected, the data of the correction function, preferably only the position-dependent part, are buffered in a data region corresponding to one image. The processing steps that are planned for the data to be detected are performed on the buffered data in this data region. The buffered data of the now-modified correction function buffered in the data region are applied to the data to be detected. As a result, in particularly advantageous fashion, the computational capacity necessary for correction of the data to be detected can be minimized. With this procedure the image data of repeated measurements of the same specimen, or the image data of several measurements of substantially identical different specimens, can in very particularly advantageous fashion also be corrected with minimized computational outlay, the processing steps necessary for the purpose being easily implementable in an overall system.

In very particularly preferred fashion, provision is made for the edge or the area of a detected feature, the intensity profile along a curve through a detected feature, and/or the localization of a detected feature or a portion thereof, to be extracted as the characteristic measurement parameter. In the metrology of line widths or positions on substrates of the semiconductor industry, the edge of a detected conductor path is of particular interest as the characteristic measurement parameter, since the edge location of the conductor path is thereby defined. If the edge location of two edges of a conductor path has been localized, its width can be determined, and the width of a conductor path also represents a characteristic measurement parameter of great interest. In addition, the intensity profile along a line transverse to the conductor path may be of interest, so that a “conductor path profile” of this kind also represents a characteristic measurement parameter.

In very particularly preferred fashion, a coordinate measuring instrument that is configured with a detector embodied as an electronic camera is provided, in particular for the metrology of line widths or positions on substrates of the semiconductor industry, said coordinate measuring instrument plus detector being suitable for carrying out a method for reading out an electronic camera as defined in one of claims 1 through 15. To eliminate repetition, the reader is therefore referred to the earlier part of the specification.

The concept by which the object of the method according to the present invention is achieved will be developed below with reference to a concrete exemplary embodiment of the method according to the present invention, and further elucidated with reference to a mathematical description.

For the CCD camera that is concretely present, the detection chip provided therein is read out by two digitization devices embodied as ADCs. The one ADC reads out all even-numbered rows, and the other ADC reads out all odd-numbered rows of the detection chip. The same number of pixels is allocated to each ADC. A correction function is in this instance a function that equalizes the differences that occur in each line because the two ADCs operate slightly differently. The equalization could, for example, proceed in such a way that a correction function Δ(j,Pᵢⱼ) is added to the pixel intensities Pᵢⱼ of the odd-numbered rows j in order to equalize the two ADCs with one another. The correction function Δ(j,Pᵢⱼ) could also just as easily be subtracted from the even-numbered lines. In very general terms, the even-numbered lines are corrected with −k_{g}Δ(j,Pᵢⱼ) and the odd-numbered lines with kᵤΔ(j,Pᵢⱼ), in which context kᵤ+k_{g}=1. i and j are the indices of the individual pixels; i addresses the columns and j the rows of a detection chip or a detected image. The corrected pixel P′ᵢⱼ can thus be represented as follows:

Pᵢⱼ′=Pᵢⱼ+k(j)Δ(j,Pᵢⱼ)

In the exemplary embodiment presented here, the correction function Δ(j,Pᵢⱼ) can be written as the product of an exclusively position-dependent part and an exclusively intensity-dependent part, the correction function Δ(j,Pᵢⱼ) having the following form:

Δ(j,Pᵢⱼ)=Δₒ(j)Δᵢ(Pᵢⱼ)

The intensity-dependent part of the correction function depends on the detected intensity of the individual pixels. The position-dependent part of the correction function refers to the position of the pixels of the detection chip of the CCD camera. The position-dependent part Δ₀(j) is defined by the following equation:

Δₒ(j)=αₒ+βₒj

in which αₒ and βₒ are parameters describing the behavior of the CCD camera. The intensity-dependent part Δᵢ(Pᵢⱼ) of the correction function is ascertained empirically and is defined to a good approximation by:

$${Δ}_{i} ( {P}_{ij} ) = ( 1 - {e}^{- \frac{{P}_{ij}}{γ}} ) ( 1 - {e}^{- \frac{{P}_{max} - {P}_{ij}}{γ}} )$$

γ is also a parameter that describes the properties of the CCD camera. Pₘₐₓ is the maximum intensity that the ADCs can digitize; for ADCs with 8-bit dynamics, Pₘₐₓ=255.

As set forth in claim 11, in order to ascertain the correction function Δ(j,Pᵢⱼ) firstly a series of images of a uniform specimen with homogeneous illumination is detected using different illumination intensities and/or different exposure times.

For each detected image, the differences in intensity with respect to adjacent pixels of the respective other digitization device are determined. Lastly, the parameters of the correction function yet to be determined are ascertained in such a way that upon application of the correction function to the detected data, the differences in intensity that then result are as small as possible for all intensities and positions in the image.

Using the correction function Δ(j,Pᵢⱼ) determined in this way, an equalization of the digitized data of the various ADCs is then performed based on the following considerations:

In the exemplary embodiment presented here, only individual rectangular ROIs of the detection chip of the CCD camera are taken into account for the extraction of characteristic measurement parameters. Thus after a detection of an individual image, only the ROIs defined by a user are processed further. The data reduction provided is an averaging for all pixels perpendicular to a position on one side of an ROI; the ROI can be defined or oriented arbitrarily in the image or on the detection chip. The averaging is thus performed along a line, the pixels along that line having been created by interpolation from the physical original pixels of the detection chip of the CCD camera. The interpolation is described by the following equation:

$${Q}_{ij} = {\sum }_{kl} {a}_{ijkl} {P}_{m ( i ) + k , n ( j ) + l}$$

in which Qᵢⱼ is the interpolated pixel and the indices k, l describe the region of the original pixels employed for interpolation, i.e. in the case of a linear interpolation, k and l each assume two values. aᵢⱼₖₗ designates the weights with which the pixels in this region are summed. The functions m(i) and n(j) determine the location of the region in the original image that belongs to the interpolated pixel Qᵢⱼ. The average Mⱼ of the interpolated pixels in column j, which is to be calculated for the data reduction, is derived as defined by the following equation:

$${M}_{j} = \frac{1}{N} {\sum }_{i = 1}^{N} {\sum }_{kl} {a}_{ijkl} {P}_{m ( i ) + k , n ( j ) + l}$$

According to the present invention, equalization of the reduced digitized data derived in this fashion is determined as defined by the following equation, in which M′ⱼ is the equalized or corrected average:

$${M}_{j}^{′} = \frac{1}{N} {\sum }_{i = 1}^{N} {\sum }_{kl} {a}_{ijkl} {P}_{m ( i ) + k , n ( j ) + l}^{′} = \frac{1}{N} {\sum }_{i = 1}^{N} {\sum }_{kl} {a}_{ijkl} ( {P}_{m ( i ) + k , n ( j ) + l} + k ( n ( j ) + l ) Δ ( n ( j ) + l , {P}_{m ( i ) + k , n ( j ) + l} )$$

This equation is reformulated with the following steps:

$${M}_{j}^{′} = \frac{1}{N} ( {\sum }_{i = 1}^{N} {\sum }_{kl} {a}_{ijkl} {P}_{m ( i ) + k , n ( j ) + l} + {\sum }_{i = 1}^{N} {\sum }_{kl} {a}_{ijkl} k ( n ( j ) + l ) Δ ( n ( j ) + l , {P}_{m ( i ) + k , n ( j ) + l} ) ) ≅ \frac{1}{N} ( {\sum }_{i = 1}^{N} {\sum }_{kl} {a}_{ijkl} {P}_{m ( i ) + k , n ( j ) + l} + {Δ}_{i} ( {P}_{j} ) {\sum }_{i = 1}^{N} {\sum }_{kl} {a}_{ijkl} k ( n ( j ) + l ) {Δ}_{0} ( n ( j ) + l ) ) = \frac{1}{N} ( {\sum }_{i = 1}^{N} {\sum }_{kl} {a}_{ijkl} {P}_{m ( i ) + k , n ( j ) + l} + {Δ}_{i} ( {P}_{j} ) {κ}_{j} )$$

$$where {κ}_{j} = {\sum }_{i = 1}^{N} {\sum }_{kl} {a}_{ijkl} k ( n ( j ) + l ) {Δ}_{0} ( n ( j ) + l$$

An equalized average is thus defined by the equation

$${M}_{j}^{′} = \frac{1}{N} ( {\sum }_{i = 1}^{N} {\sum }_{kl} {a}_{ijkl} {P}_{m ( i ) + k , n ( j ) + l} + {Δ}_{i} ( {P}_{j} ) {κ}_{j} )$$

The portion to the left of the plus sign is identical to the average Mⱼ for uncorrected values. To the right of the plus sign, the summation no longer affects the brightness of the pixels but only the position of the ROI, so that this part of the calculation needs to be performed only once for each position of the ROI. kⱼ is thus calculated quite similarly to the uncorrected average Mⱼ, using the expression k(n(j)+l)·Δ₀(n(j)+l) as the “brightness.” Because in a typical metrology application, a series of images is always acquired of a given ROI, but the position-dependent component needs to be ascertained only once, the computational capacity required can thus be considerably reduced.

### BRIEF DESCRIPTION OF THE DRAWINGS

In the drawings:

FIG. 1 is a diagram of an intensity profile across a conductor path of a wafer exposure mask, detected with a coordinate measuring instrument in combination with a CCD camera; and

FIG. 2 is a diagram of the intensity profile from FIG. 1 in which, however, according to the present invention, equalization of the reduced digitized data of the various digitization devices of the CCD camera has been accomplished.

### DETAILED DESCRIPTION OF THE INVENTION

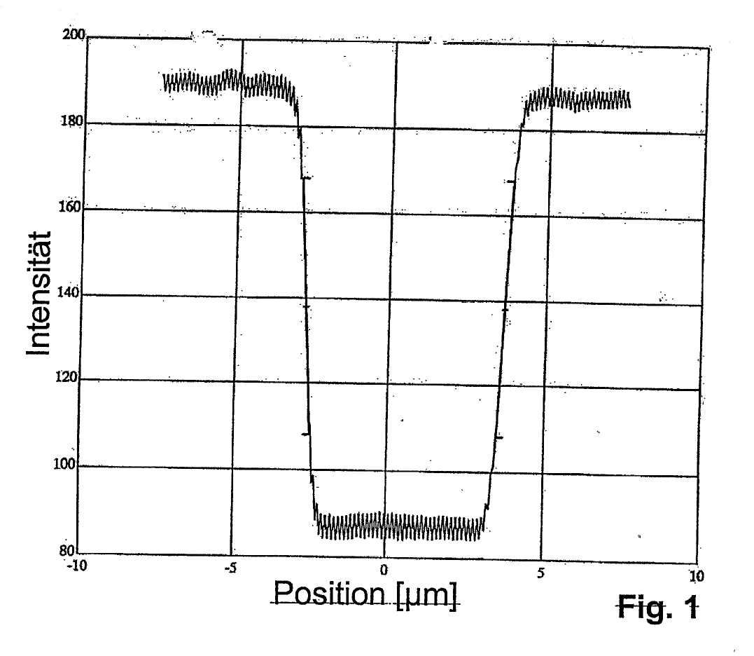

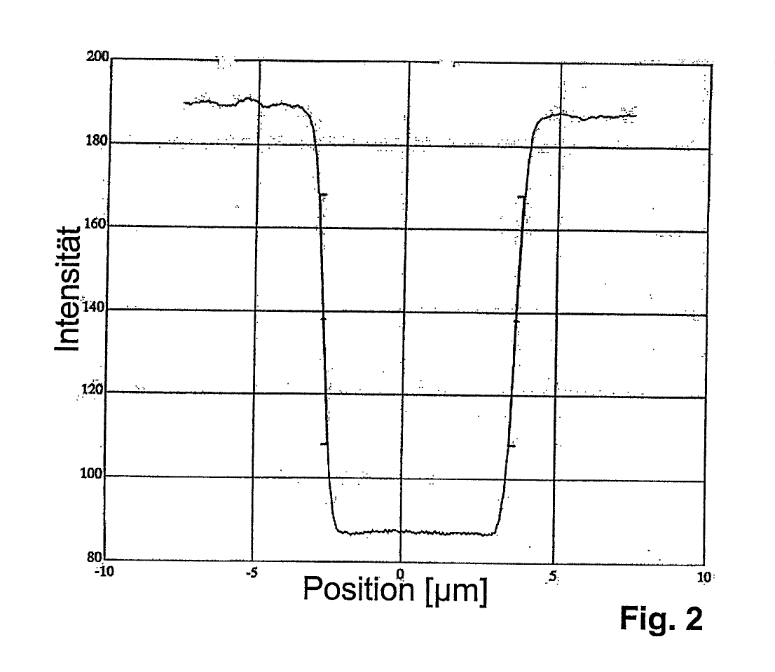

In the diagram of FIG. 1, the detected intensity is plotted as a function of position in the ROI. The ROI in FIGS. 1 and 2 is 20 μm wide and extends from −10 μm to 10 μm. The detected intensity is the digitized data read out from the digitization devices, which has been subjected to a data reduction (in this case, an averaging). The conductor path is located in the region between −2 μm and 3 μm. It is evident from the zigzag profile of the digitized intensity values in this region that the two ADCs reading out the detection chip of the CCD camera do not operate identically, and therefore supply different intensity values as their results. The lower intensities are the digitized values supplied by the ADC with which the even-numbered rows of the detection chip are associated. The higher intensities in this region are the digitized values supplied by the ADC with which the odd-numbered rows of the detection chip are associated. After equalization according to the present invention with the correction function determined in a calibration step, what results is a corrected intensity profile of the measured conductor path that is shown in FIG. 2. Here, in very particularly advantageous fashion, the regions of the intensity profile that exhibit an almost constant intensity value, or the region between −2 μm and 3 μm, no longer exhibits a zigzag profile such as was present in the original data.

In conclusion, be it noted very particularly that the exemplary embodiment discussed above serves merely to describe the teaching claimed, but does not limit it to the exemplary embodiments.

What is claimed is:

1. A method for reading out a detection chip of an electronic camera in a coordinate measuring instrument wherein said coordinate measuring instrument determines the position of an edge of a feature on a substrate, comprising the steps:
reading out the detection chip by means of at least two digitization devices, with each of which individual pixels of the detection chip are associated,
the digitized data read out by the digitization devices being subjected to a data reduction in order to extract characteristic measurement parameters,
wherein an equalization of the reduced digitized data of the various digitization devices is accomplished with a correction function.

2. The method as defined in claim 1, wherein the data reduction encompasses a preferably orthogonal projection onto a line in an image detected by the camera.

3. The method as defined in claim 1, wherein the data reduction encompasses a summation, in particular an averaging.

4. The method as defined in claim 2, wherein the data reduction encompasses a summation, in particular an averaging.

5. The method as defined in claim 1, wherein the individual pixels of the detection chip that are associated with the digitization devices are combined into rows or columns.

6. The method as defined in claim 2, wherein the individual pixels of the detection chip that are associated with the digitization devices are combined into rows or columns.

7. The method as defined in claim 3, wherein the individual pixels of the detection chip that are associated with the digitization devices are combined into rows or columns.

8. The method as defined in claim 1, wherein the correction function has a position-dependent part and an intensity-dependent part.

9. The method as defined in claim 1, wherein the correction function comprises the product of an exclusively position-dependent part and an exclusively intensity-dependent part.

10. The method as defined in claim 1, wherein the detection chip is used as the position detector of the coordinate measuring instrument.

11. The method as defined in claim 1, wherein only one evaluation window of the detection chip is taken into consideration for extraction of the characteristic measurement parameters.

12. The method as defined in claim 11, wherein in a rectangular evaluation window oriented arbitrarily in the image, a pixel grid parallel to the sides of the readout window is calculated, optionally by interpolation.

13. The method as defined in claim 1, wherein the correction function is ascertained in a calibration operation.

14. The method as defined in claim 13, said calibration operation comprising:
a) detecting a series of images of a uniform specimen with homogeneous illumination, using different illumination intensities and/or different exposure times;
b) determining, for each detected image, the differences in the intensities with respect to adjacent pixels of the respective other digitization device; and
c) ascertaining the parameters of the correction function yet to be determined in such a way that upon application of the correction function to the detected data, the differences in the intensities that then occur are minimal for all intensities and positions.

15. The method as defined in claim 8, wherein data of the correction function, preferably only the position-dependent part, are buffered in a data region corresponding to one image.

16. The method as defined in claim 9, wherein data of the correction function, preferably only the position-dependent part, are buffered in a data region corresponding to one image.

17. The method as defined in claim 15, wherein the processing steps that are planned with the data to be detected are performed in this data region; and the result thereof is buffered in said data region.

18. The method as defined in claim 16, wherein the processing steps that are planned with the data to be detected are performed in this data region; and the result thereof is buffered in said data region.

19. The method as defined in claim 17, wherein the data buffered in the data region are applied to the data to be detected.

20. The method as defined in claim 18, wherein the data buffered in the data region are applied to the data to be detected.

21. The method as defined in claim 1, wherein the edge or the area of a detected feature, the intensity profile along a curve through a detected feature, and/or the localization of a detected feature or a portion thereof, are extracted as the characteristic measurement parameter.
